(19) United States
(12) Patent Application Publication
(10) Pub. No.: US 2004/0261578 A1
(43) Pub. Date: Dec. 30, 2004

(54) Stable self-organizing plant-organism systems for remediating polluted soils and waters

(76) Inventors: Gary E. Harman, Geneva, NY (US); James M. Lynch, West Sussex (GB); Matteo Lorito, Capezzano (IT)

Correspondence Address: Michael L. Goldman, Esq., Nixon Peabody LLP, Clinton Square, P.O. Box 31051, Rochester, NY, 14603-1051, US

(21) Appl. No.: 10/818,525

(22) Filed: Apr. 5, 2004

Related U.S. Application Data
(60) Provisional application No. 60/460,847, filed on Apr. 4, 2003.

(51) Int. Cl. A01N 63/00; A01N 63/04; A01N 65/00; C21B 9/00; C22B 9/00

(52) U.S. Cl. 75/710

(57) ABSTRACT

The present invention provides methods for remediating polluted soils or water, removing toxic substances from polluted soils or water, and removing polluting plant nutrients from water using a plant-organism system or specific microbes added to the polluted land or water. Also provided is a method for enhancing the development of root hairs and fine roots in plants using rhizosphere competent microbes and a method for increasing crop plant yield.

This application claims the benefit of U.S. Provisional Patent Application Ser. No. 60/460,847, filed Apr. 4, 2003.

This invention was developed with government funding under BARD (USDA-ARS) Grant No. US-2880-97. The U.S. Government may have certain rights.

### FIELD OF THE INVENTION

The present invention relates to a method for remediating and preventing pollution of soils or water that involves a plant-organism system of detoxification.

### BACKGROUND OF THE INVENTION

Modem industry, agriculture, and other human activities produce large quantities of materials that pollute soils and water. For example, intensive agricultural systems and industrial processes place large quantities of nitrates and phosphorus into waterways. Similar pollution may arise from water treatment systems used to treat animal or human sewage. In the USA, concentrations of nitrates at or above the U.S. Environmental Protection Agency (EPA) maximum contaminant level (MCL) of 10 ppm for drinking water were detected in 15% of samples collected in shallow ground water beneath agricultural and urban lands, which is a concern for rural areas where shallow aquifers are used for drinking water supplies (U.S. Geological Survey: The Quality of our Nation's Waters—Nutrients and Pesticides. U.S. Geological Survey Circular 1225 (1999)). Within the Mississippi River basin, nitrate is found at concentrations approaching the MCL (Antweiler et al., “Nutrients in the Mississippi River,” U.S. Geological Survey Circular 1122: 1-11 (2000)). Nitrate and phosphorus pollution contribute to the zone of hypoxia along the coast of the USA in the Gulf of Mexico and other regions and may also encourage growth of toxic estuarine organisms such as Pfiesteria. These environmental costs are high—the EPA estimates that harmful algal blooms may have been responsible for an estimated $1,000,000,000 in economic losses during the past decade.

In addition, agriculture and other industries have added toxic elements to the soils. For example, lead, arsenic, mercury, and cadmium compounds were used as pesticides, as were DDT and similar organic compounds. All of these materials are highly persistent and may still be present in soils or sediments at levels sufficiently high to cause human health concerns. Mining and other industries, such as wood treatment processes, may also result in accumulation of toxic elements such as arsenic, lead, chromium, copper, zinc, and other materials. Moreover, electroplating industries, manufactured gas plants, mining and metal recovery systems, processing of cyanogenic crops, and paint manufacturing industries can produce cyanide and metallocyanides that pollute soils and waterways (Dubey et al., “Biological Cyanide Destruction Mediated by Microorganisms,” World J. Microbiol. Biotechnol. 11:257-265 (1995); Shifrin et al., “Chemistry, Toxicology and Human Health Risk of Cyanide Compounds in Soils at Former Manufactured Gas Plant Sites,” Regulatory Toxicol. Pharmacol. 23:106-116 (1996)).

Similarly, various industries that rely upon or produce petrochemicals may result in production of toxic and carcinogenic polycyclic aromatic hydrocarbons.

Remediation of pollution has most commonly used physio-chemical methods that generally are expensive and cumbersome. Biological systems, in particular bioremediation and phytoremediation, also have been used. Bioremediation usually consists of adding organisms to a polluted system, usually in the presence of glucose or other nutrients, to degrade toxic compounds. Augmentation refers to the addition of a nutrient source to a polluted site in the hopes that organisms with the capabilities to degrade the toxicant are present and that they will proliferate to levels sufficient to degrade the toxicant. Certainly, organisms with adequate capabilities to degrade or remove toxicants are known. However, a common failing to these approaches is that the organisms used frequently are overtaken or outgrown by other organisms, especially when glucose or other nutrients are added. This may necessitate their use in highly controlled conditions, such as a bioreactor. This adds to costs and increases the difficulties in large-scale processing of polluted materials. Furthermore, some organisms with otherwise useful properties may be toxic or pathogenic to plants or animals and this limits their usefulness.

Phytoremediation refers to plants used to remediate polluted sites. Subcategories include phytoextraction, i.e., the use of plants that accumulate toxicants from soils or waters where they can be removed; phytostabilization, i.e., the use of plants that stabilize pollutants in soils rendering them harmless; rhizofiltration, i.e., the use of plants whose roots are grown in aerated water systems that precipitate or flocculate toxic materials from polluted effluents; and phytovolatilization, i.e., the use of plants that can extract volatile pollutants (e.g., tritium, mercury or selenium) from soil or that extract pollutants and convert them to a volatile form and volatilize them from foliage (Raskin et al., Phytoremediation of Toxic Metals, New York: John Wiley & Sons (2000)).

Generally, bioremediation has been considered primarily for degradation of toxic compounds such as polycyclic aromatic hydrocarbons and cyanide, while phytoremediation has been used to remove toxic elements (Raskin et al., Phytoremediation of Toxic Metals, New York: John Wiley & Sons (2000)). No single biological system, to date, is capable of remediating both soils and waters that have been contaminated with any of a wide variety of pollutants.

Thus, there are many shortcomings and problems that exist in the technologies currently available for the remediation and detoxification of polluted soil and water.

The present invention is directed to overcoming these and other deficiencies in the art.

### SUMMARY OF THE INVENTION

The present invention relates to a method for remediating a polluted environmental area. This method involves providing a plant or a plant seed, and providing a fungal or bacterial organism, where the organism is capable of colonizing plant roots. The organism is combined with the plant or the plant seed under conditions effective for the organism to colonize the roots of the plant or a plant grown from the plant seed, thereby creating a plant-organism system. The plant-organism system is introduced to the polluted environmental area, thereby remediating the environmental area.

The present invention also relates to a method for removing a toxic substance from an environmental area. This method involves providing a plant or a plant seed, where the plant or the plant grown from the plant seed is capable of uptake of toxic substances. Also provided is a fungal or bacterial organism, where the-organism is capable of colonizing plant roots. The organism is combined with the plant or the plant seed under conditions effective for the organism to colonize the roots of the plant or of a plant grown from the plant seed, thereby creating a plant-organism system capable of the uptake of toxic substances. The plant-organism system is introduced to the environmental area where uptake of the toxic elements into the plant is allowed. The plant is removed from the environmental area, thereby removing the toxic substance from the environmental area.

The present invention also relates to another method for removing pollutants from an environmental area. This method involves introducing fungi and bacteria to a polluted environmental area under conditions effective to allow the fungi to grow, thereby removing pollutants from the environmental area.

Another aspect of the present invention is a method of enhancing the development of plant fine roots and root hairs. The method involves providing a plant and one or more symbiotic rhizosphere competent microbes. The one or more symbiotic rhizosphere competent microbes are introduced to the plant under conditions effective for the one or more microbes to colonize the roots of the plant, thereby enhancing the development of plant fine roots and root hairs.

Yet another aspect of the present invention is a method of increasing the yield of crop plants. This method involves providing a crop plant or a crop plant seed and a symbiotic fungal organism capable of colonizing plant roots, where the fungal organism is selected from the group consisting of Trichoderma spp., Penicillium spp., Fusarium spp., and Rhizoctonia spp. Also provided is a symbiotic bacterial organism, capable of colonizing plant roots, where the bacterial organism is selected from the group consisting of Rhizobium spp., Bradyrhizobium spp., Pseudomonas spp., and Bacillus spp. The fungal organism and the bacterial organism are combined with the crop plant or crop plant seed under conditions effective for the fungal organism and the bacterial organism to colonize the roots of the plant or a plant grown from the plant seed, thereby increasing the yield of the crop plant.

Rhizosphere competent organisms have been recently shown to be plant symbionts. Fungi in the genus Trichoderma colonize the root and actually penetrate and colonize the outer cells of the plant root. They exchange signaling compounds with the plant that change the plant's physiology and gene expression. Effects of these changes include increased resistance of the plant to disease causing agents, enhanced root growth and development, and increased yield. These effects on plants are described in Harman et al., “Trichoderma Species—Opportunistic, Avirulent Plant Symbionts,” Nature Microbiol Rev 2:43-56, (2004), which is hereby incorporated by reference in its entirety.

The present invention provides an efficient biological system that alleviates the existing need for a self-contained biological tool for remediation and detoxification of water and soils.

### BRIEF DESCRIPTION OF THE DRAWINGS

FIGS. 1A-B are photographs showing the uptake up metallocyanides into fungi. The dark nodules are Trichoderma colonies that have taken up the metallocyanide in the presence (FIG. 1A) or absence (FIG. 1B) of glucose. Note that the uptake ability of Trichoderma in the presence of glucose is more efficient than it is in the absence of glucose.

FIG. 2 is a graph showing percent reduction of total phenols in olive oil waste water after treatment by different Trichoderma strains.

### DETAILED DESCRIPTION OF THE INVENTION

The present invention relates to a method for remediating a polluted environmental area. This method involves providing a plant or a plant seed, and providing a fungal or bacterial organism, where the organism is capable of colonizing plant roots. The organism is combined with the plant or the plant seed under conditions effective for the organism to colonize the roots of the plant or a plant grown from the plant seed, thereby creating a plant-organism system. The plant-organism system is introduced to the polluted environmental area, thereby remediating the environmental area.

The self-organizing plant-microbe association of the present invention has numerous applications for the remediation or prevention of pollution by a range of toxic materials. Either the plant or the microbe can be used alone, but in most cases the synergism between the plant and microbial organism provides greater benefits than either used alone. The-plant-organism system of the present invention, as described in greater detail herein below, is suitable for use in the remediation and detoxification of soils as well as water. Therefore, as used herein, an ‘environmental area’ is meant to include soils, water, and combinations thereof.

The present invention also relates to a method for removing a toxic substance from an environmental area. This method involves providing a plant or a plant seed, where the plant or the plant grown from the plant seed is capable of uptake of toxic substances. Also provided is a fungal or bacterial organism, where the organism is capable of colonizing plant roots. The organism is combined with the plant or the plant seed under conditions effective for the organism to colonize the roots of the plant or of a plant grown from the plant seed, thereby creating a plant-organism system capable of the uptake of toxic substances. The plant-organism system is introduced to the environmental area where uptake of the toxic elements into the plant is allowed. The plant is removed from the environmental area, thereby removing the toxic substance from the environmental area.

The present invention also relates to another method for removing pollutants from an environmental area. This method involves introducing fungi and bacteria to a polluted environmental area under conditions effective to allow the fungi to grow, thereby removing pollutants from the environmental area.

The present invention also relates to a method of enhancing the development of plant fine roots and root hairs. The method involves providing a plant and providing a symbiotic rhizosphere competent microbe, which may be a fungus or bacterium, to include, without limitation, those described herein below. The symbiotic rhizosphere competent microbe is introduced to the plant under conditions effective for the microbe to colonize the roots of the plant, thereby enhancing the development of plant fine roots and root hairs.

Phytobial systems are self-organizing plant-organism associations that combine phytobial- and microbial-based remediation. These systems have great flexibility and can be broadly adapted to a range of remediation situations. Recently, in European Patent application EC 0128180.7, fungi in the genus Trichoderma were shown to be capable of catabolizing cyanide (CN) both in vitro and in vivo. In the latter case, the fungi were added to soils to which cyanide solutions were added and seeds were planted. In the absence of cyanide the seedlings grew normally from the seeds, but the addition of 10 mM cyanide severely limited seedling growth. However, in the presence of any of several different Trichoderma strains, the germinating seeds provided a nutrient source for the fungus, permitting its growth. The fungi produced enzymes that degraded the cyanide and permitted normal growth of seedlings even at 10 mM.

It has also been shown that some strains of Trichoderma spp., particularly T. harzianum strain T22, are strongly able to colonize roots and to grow with the developing root system (Harman, G. E., “The Myths and Dogmas of Biocontrol. Changes in Perceptions Based on Research with Trichoderma harzianum T-22,” Plant Disease 84:377-393 (2000), which is hereby incorporated by reference in its entirety). This property is known as rhizosphere competence and is rare among these or other fungi (Chao et al., “Colonization of the Rhizosphere by Biological Control Agents Applied to Seeds,” Phytopathology 76:60-65 (1986); Harman, G. E., “The Development and Benefits of Rhizosphere Competent Fungi for Biological Control of Plant Pathogens,” J. Plant Nutrition 15:835-843 (1992), which are hereby incorporated by reference in their entirety).

Perhaps the most strongly rhizosphere competent strain of Trichoderma is T. harzianum strain T22 (a.k.a. KRL-AG2, ATCC 20847, and 1295-22); it and sister strains are claimed in U.S. Pat. No. 5,260,213 to Harman et al., which is hereby incorporated by reference in its entirety. Other strains also are rhizosphere competent, including T. virens strain 41 and sister strains, which were formerly classified as Gliocladium virens (U.S. Pat. Nos. 4,996,157 and 5,165,928 to Smith, which are hereby incorporated by reference in their entirety). Various bacteria, including Pseudomonas, Bacillus, and Rhizobium are rhizosphere competent by the definitions herein, as are ecto- and endo-mycorrhizal fungi.

For the purposes of the present invention, rhizosphere competence can be assessed by the following method: seeds of any convenient plant species (cotton, beans, or corn are preferred) are treated with the strain of interest by application of conidia or other propagative structures of the strain suspended in water or water containing an adhesive such as carboxymethyl cellulose or other material common to the seed coating trade. Dusting of the seeds with a preparation of the organism of choice can also be used. Typically the microbial suspension or dust should contain approximately 10⁷ to 10⁸ propagules/ml or g. Seeds are then planted in soil or commercial planting mix at a moisture level conducive to seed germination. The seedlings are grown from treated or untreated seeds without further watering in a closed system until roots are 10-15 cm in length. A useful arrangement, essentially as in Sivan & Harman (Sivan et al., “Improved Rhizosphere Competence in a Protoplast Fusion Progeny of Trichoderma harzianum,” J. Gen. Microbiol. 137:23-29 (1991), which is hereby incorporated by reference in its entirety), for such assays is to grow individual seedlings in a 2.5 cm diameter split plastic (e.g., PVC) pipe 15 cm long. The pipe halves are held together with rubber bands or tape and filled with soil or planting medium. One seed is planted in the soil at the top of the pipe and seedlings grown until they reach the desired size. Pipes containing seedlings are contained within a closed container to prevent evaporation of moisture and with a layer of moist planting medium at the bottom of the container. This arrangement provides a system that avoids the need for watering of the soil. Watering may carry propagules from treated seeds into the planting mix into the lower soil volume, which must be avoided. When seedlings are of the desired size the two halves of the pipe are separated and the root carefully removed from the soil or planting medium. The distal 1 cm end of the root is excised and either plated directly or washed to remove spores. The excised root tips or spore washings are then plated onto an appropriate medium for detection of the organism. For Trichoderma spp., a preferred medium is acid potato dextrose agar made according to the manufacturer's directions (Difco, Detroit, Mich.) and containing 1% of the colony-restricting agent Igepal Co630 (Alltech Associates, Deerfield, Ill.). The acidic nature of the medium prevents growth of most interfering bacteria and the colony restricting agent assists in enumeration of colony numbers. A rhizosphere competent strain is defined as one that, following application as a seed treatment, results in colonization of root tips of at least 80% of seedlings in the assay just described. This assay is appropriate for free-living organisms but not for obligate root colonists such as Rhizobium and related genera and endo- and ecto-mycorrhizal fungi. Activity of Rhizobium spp. is evidenced by the formation of nodules on roots and activity of endo- or ecto-mycorrhizal fungi are evidenced by formation of characteristic structures on or in roots. It should be noted that rhizosphere competence is rare, and occurs only with a few strains of organisms even within the genera noted, with the exception of obligate root colonizing organisms such as Rhizobium and related spp. and endo- and ecto-mycorrhizae.

Organisms suitable for the present invention are organisms with strong abilities to colonize roots. This ability is known as rhizosphere competence, which is used herein to describe those organisms capable of colonizing the root surface or the surface plus surrounding soil volume (rhizoplane and rhizosphere, respectively), when applied as a seed or other point source at the time of planting in absence of bulk flow of water. Thus, the organisms of the present invention have the physiological and genetic ability to proliferate the root as it develops. Rhizosphere competence is not an absolute term, and degrees of this ability may occur among strains (Harman, G. E., “The Development and Benefits of Rhizosphere Competent Fungi for Biological Control of Plant Pathogens,” J. Plant Nutrition 15:835-843 (1992); U.S. Pat. Nos. 4,996,157 and 5,165,928 to Smith, which are hereby incorporated by reference in their entirety). Other organisms, including those in the genera Bacillus, Pseudomonas, and Burkholderia, also possess good root competence (Brannen et al., “Kodiak: A Successful Biological-Control Product for Suppression of Soil-Borne Plant Pathogens of Cotton,” J. Industr. Microbiol. Biotechnol. 19:169-171 (1997); Kloepper et al. “Plant Growth Promoting Rhizobacteria As Inducers of Systemic Acquired Resistance,” In: Lumsden, R. D. and Vaughn, J. L. (ed.): Pest Management: Biologically Based Technologies. Washington, D.C., pp. 10-20 (1993), which are hereby incorporated by reference in their entirety). Procedures for measuring rhizosphere competence are known to those skilled in the art (Harman et al., “Combining Effective Strains of Trichoderma harzianum and Solid Matrix Priming to Improve Biological Seed Treatments,” Plant Disease 73:631-637 (1989); Harman, G. E., “The Myths and Dogmas of Biocontrol. Changes in Perceptions Based on Research with Trichoderma harzianum T-22,” Plant Disease 84:377-393 (2000); Kloepper et al., “A Review of Issues Related to Measuring Colonization of Plant Roots by Bacteria,” Can J. Microbiol. 38:1219-1232 (1992), which are hereby incorporated by reference in their entirety). Either fungal or bacterial agents may be rhizosphere competent. Examples of organisms with these capabilities which are suitable as root development enhancing agents of the present invention are beneficial microorganisms including, but not limited to, fungi in the genus Trichoderma (U.S. Pat. No. 5,260,213 to Harman et al., which is hereby incorporated by reference in its entirety), including T. virens, formerly classified as Gliocladium virens (U.S. Pat. No. 5,165,928 to Smith et al., which is hereby incorporated by reference in its entirety); and bacteria in the genus Bacillus (Raupauch-Georg et al., “Mixtures of Plant Growth-Promoting Rhizobacteria Enhance Biological Control of Multiple Cucumber Pathogens,” Phytpathology 88:1158-1164 (1998), which is hereby incorporated by reference in its entirety); Pseudomonas and Burkholderia (Burr et al., “Increased Potato Yields by Treatment of Seedpieces with Specific Strains of Pseudomonas fluorescens and P. putida,” Phytpathology 68:1377-1383 (1978), which is hereby incorporated by reference in its entirety); Streptomyces, and Fusarium.

Recently, Trichoderma have been demonstrated to be opportunistic avirulent plant symbionts (Harman et al., “Trichoderma Species—Opportunistic, Avirulent Plant Symbionts,” Nature Microbiol Rev 2:43-56, (2004), which is hereby incorporated by reference in its entirety). These fungi clearly are opportunistic, since they can proliferate, compete, and survive in soil and other complex ecosystems. They are capable of invading roots, but are typically restricted to the outer layers of the cortex (Yedidia et al., “Induction of Defense Responses in Cucumber Plants (Cucumis sativus L.) by the Biocontrol Agent Trichoderma harzianum,” Appl Environ Microbiol 65:1061-1070 (1999), which is hereby incorporated by reference in its entirety), probably due to production by the fungi of several classes of compounds that act as signals for the plant to activate resistance responses based on chemical and structural mechanisms (Harman et al., “Trichoderma Species—Opportunistic, Avirulent Plant Symbionts,” Nature Microbiol Rev 2:43-56 (2004), which is hereby incorporated by reference in its entirety). This root infection followed by limitation of fungal proliferation within the root allows the fungi to grow and to develop using the energy sources of the plant. Not only do the fungi grow based upon resources provided by the plant, but they also are carried through soil and occupy new soil niches as a consequence of root colonization. Thus, root-associated Trichoderma spp. derive numerous benefits from plants. The fact that the organisms are carried through the soil and, thereby, reach areas inaccessible to them in the absence of the plant is an important advantage of this invention.

Plants also derive numerous advantages from root colonization by these opportunistic root symbionts. One important advantage is protection of plants against diseases by direct action of the Trichoderma strains on pathogenic microbes (Chet, I., “Trichoderma-Application, Mode of Action, and Potential as a Biocontrol Agent of Soilborne Plant Pathogenic Fungi,” In Innovative Approaches to Plant Disease Control, pp. 137-160, I. Chet, ed., J. Wiley and Sons: New York (1987), which is hereby incorporated by reference in its entirety) or other deleterious soil microflora (Bakker et al., “Microbial Cyanide Production in the Rhizosphere in Relation to Potato Yield Reduction and Pseudomonas spp-Mediated Plant Growth-Stimulation,” Soil Biol Biochem 19:451-457 (1987), which is hereby incorporated by reference in its entirety).

Another advantage is protection against plant pathogens due to systemic induction of resistance. This permits plants to be protected at a point widely separated (temporally or spatially) from application of Trichoderma (Harman et al., “Trichoderma Species—Opportunistic, Avirulent Plant Symbionts,” Nature Microbiol Rev 2:43-56, (2004), which is hereby incorporated by reference in its entirety). For example, through induced resistance, Trichoderma spp. can control foliar pathogens even when it is present only on the roots.

In addition, colonization promotes the enhancement of plant growth and development, especially of roots. The activity of Trichoderma spp. added to soil increases plant growth and development. This fact seems counterintuitive since, no doubt, the root colonization and induction of resistance is energetically expensive to the plants, but it is a phenomenon that is commonly observed on a variety of plants. Some of this improved plant growth likely occurs as a consequence of control of pathogenic or other deleterious microbes, but it also has been demonstrated in axenic systems (Harman, G. E., “Myths and Dogmas of Biocontrol. Changes in Perceptions Derived From Research on Trichoderma harzianum T-22,” Plant Disease 84, 377-393 (2000); Harman et al., “Trichoderma Species—Opportunistic, Avirulent Plant Symbionts,” Nature Microbiol Rev 2:43-56, (2004), which are hereby incorporated by reference in their entirety), so it is no doubt a consequence of direct effects on plants as well as a biological control phenomenon (Harman et al, “Interactions Between Trichoderma harzianum Strain T22 and Maize Inbred Line Mo 17 and Effects of this Interaction on Diseases Caused by Pythium ultimum and Colletotrichum graminicola,” Phytopathology 94:147-153 (2004), which is hereby incorporated by reference in its entirety).

These facts directly demonstrate that Trichoderma spp. have a strong beneficial effect upon plants. Thus, at least some strains function as plant symbionts. This is a strain-specific ability, however, since some strains in some conditions may produce toxic metabolites and so the balance between toxicants and growth promoting effects determines their net effect (Ousley et al., “Effect of Trichoderma on Plant Growth: A Balance Between Inhibition and Growth Promotion,” Microbial Ecol 26:277-285 (1993), which is hereby incorporated by reference in its entirety). With other strains, negative effects usually are not seen regardless of inoculum level or environmental conditions (Harman, G. E., “The Myths and Dogmas of Biocontrol. Changes in Perceptions Based on Research with Trichoderma harzianum T-22,” Plant Disease 84:377-393 (2000), which is hereby incorporated by reference in its entirety). However, there is a strong interaction with the plant genotype that determines the level of plant growth promotion that is observed with any specific plant-symbiotic microbe interaction (Harman et al., “Interactions Between Trichoderma harzianum Strain T22 and Maize Inbred Line Mo 17 and Effects of This Interaction on Diseases Caused by Pythium ultimum and Colletotrichum graminicola,” Phytopathology 94:147-153 (2004), which is hereby incorporated by reference in its entirety). Accordingly, another aspect of the present invention is a method of increasing the yield of crop plants. This method involves providing a crop plant or a crop plant seed and a symbiotic rhizosphere competent fungal organism capable of colonizing plant roots. Suitable fungal organisms include those described above, including, but not limited to Trichoderma spp., Penicillium spp., Fusarium spp., and Rhizoctonia spp. Also provided is a symbiotic rhizosphere competent bacterial organism capable of colonizing plant roots. Suitable bacterial organisms include those described above, including, but not limited to Rhizobium spp., Bradyrhizobium spp., Pseudomonas spp., and Bacillus spp. The fungal organism and the bacterial organism are combined with the crop plant or crop plant seed under conditions effective for the fungal organism and the bacterial organism to colonize the roots of the plant or a plant grown from the plant seed, thereby increasing the yield of the crop plant. As described in greater detail in Example 2, below, a highly effective symbiotic system for enhance crop yield is created by combining the fungus T. harzianum with bacteria of the genus Bradyrhizobium.

It should be noted that root-colonizing Trichoderma strains are not the only organisms that provide similar benefits. For example, the PGPR (plant growth promoting rhizobacteria), including strains of Pseudomonas and Bacillus spp. (Kloepper et al., “Plant Growth Promoting Rhizobacteria as Inducers of Systemic Acquired Resistance,” In Pest Management: Biologically Based Technologies, pp. 10-20, R. D. Lumsden & J. L. Vaughn, eds. Washington, D.C. (2003); Ryu et al., “Bacterial Volatiles Promote Growth in Arabidopsis,” Proc Nat Acad Sci USA 100:4927-4932) (2003), which are hereby incorporated by reference in their entirety) both induce systemic resistance and enhance plant growth. Several other fungi, including nonpathogenic strains of Fusarium and Rhizoctonia spp., mycorrhizal fungi, and Penicillium spp., may colonize superficial layers of roots and induce systemic resistance (Fravel et al., “Fusarium oxysporum and Its Biocontrol,” New Phytol 157:493-502 (2003); Hwang et al., “Effects of Rhizobia, Metalaxyl, and Mycorrhizal Fungi on Growth, Nitrogen Fixation, and Development of Root Rot of Sainfoin,” Plant Disease 77, 1093-1098 (1993); Pozo et al., “Localized Versus Systemic Effect of Arbuscular Mycorrhizal Fungi on Defense Responses of Phytophthora Infection in Tomato Plants,” J Exp Botany 53, 525-534 (2002), which are hereby incorporated by reference in their entirety). This suggests that the ability to (a) infect plant roots, (b) induce the plants to limit the level of infection and induce generalized resistance mechanisms in the plant, and (c) enhance plant growth and development evolved independently numerous times within different fungal genera and is a useful survival strategy (Harman et al., “Trichoderma Species—Opportunistic, Avirulent Plant Symbionts,” Nature Microbiol Rev 2:43-56, (2004), which is hereby incorporated by reference in its entirety).

The microbial organisms of the present invention can be produced in large quantities in-either liquid or semi-solid fermentation by routine microbial techniques, such as those described in Harman et al., “Potential and Existing Uses of Trichoderma and Gliocladium For Plant Disease Control and Plant Growth Enhancement,” In Trichoderma and Gliocladium, Harman et al., eds., Vol. 2, London: Taylor and Francis (1998), which is hereby incorporated by reference in its entirety. Those skilled in the art will appreciate that the physiology and type of propagule (e.g., hyphae, conidia, or chlamydospores) of the source organism will dictate preparation schema and optimization of yield.

In one aspect of the present invention, the organism is a highly rhizosphere competent fused strain of T. harzianum known as “T-22” (ATCC 20847) (U.S. Pat. No. 5,260,213 to Harman et al.; Harman, G. E., “The Myths and Dogrnas of Biocontrol. Changes in Perceptions Based on Research with Trichoderma harzianum T-22,” Plant Disease 84:377-393 (2000), which are hereby incorporated by reference in their entirety). Any natural, mutant or fused or genetically modified strains of the genera of the present invention shown to be rhizosphere competent are also suitable for all aspects of the present invention.

Trichoderma spp. and other organisms, including Gliocladium spp., Pseudomonas spp., Bacillus spp., and others have strong biocontrol abilities. Trichoderma spp. may directly attack other fungi (mycoparasitism) (Chet et al., “Mycoparasitism and Lytic Enzymes,” In Trichoderma and Gliocladium, Harman et al., eds., Vol. 2, London: Taylor and Francis, pp. 153-172 (1998), which is hereby incorporated by reference in its entirety) or directly induce resistance in the plant itself (Yedidia et al., “Induction of Defense Responses in Cucumber Plants (Cucumis sativus L.) by the Biocontrol Agent Trichoderma harzianum,” Applied and Environmental Microbiology 65:1061-1070 (1999); Yedidia et al., “Induction and Accumulation of PR Proteins Activity During Early Stages of Root Colonization by the Mycoparasite Trichoderma harzianum Strain T-203,” Plant Physiol. Biochem. 38:863-873 (2000), which are hereby incorporated by reference in their entirety). Other strains of this same genus of fungi control competitive organisms by production of antibiotics (Claydon et al., “Antifungal Alkyl Pyrones of Trichoderma harzianum,” Trans. Br. Mycol. Soc. 88:503-513 (1987); Howell, C. R., “The Role of Antibiosis in Biocontrol,” In Trichoderma and Gliocladium, Harman et al., eds., London Taylor and Francis, Vol. 2., pp. 173-184 (1998), which are hereby incorporated by reference in their entirety). One consequence of antimicrobial activity by Trichoderma spp. and other biocontrol organisms is that rhizosphere competent strains are extremely competitive in the root zone of plants and displace other fungi so that they become the dominant organism on root surfaces. Moreover, these organisms colonize roots of all plants tested and in a wide variety of soil types (Harman, G. E., “The Myths and Dogmas of Biocontrol. Changes in Perceptions Based on Research with Trichoderma harzianum T-22,” Plant Disease 84:377-393 (2000), which is hereby incorporated by reference in its entirety). These abilities make this plant-organism interaction extremely robust and reproducible.

These same fungi also increase plant growth. In many cases, they cause plants to become greener and to increase plant yields (Harman, G. E., “The Myths and Dogmas of Biocontrol. Changes in Perceptions Based on Research with Trichoderma harzianum T-22,” Plant Disease 84:377-393 (2000), which is hereby incorporated by reference in its entirety). They result in more and deeper roots and reduce the nitrogen requirement for maize growth presumably by enhancing nitrogen uptake. This capability is being used to reduce nitrogen requirements for maize producers. The same organism also increases tolerance of plants to drought (Harman, G. E., “The Myths and Dogmas of Biocontrol. Changes in Perceptions Based on Research with Trichoderma harzianum T-22,” Plant Disease 84:377-393 (2000), which is hereby incorporated by reference in its entirety).

Strain T22 has undergone toxicity testing and has been widely used in agriculture as a biocontrol and plant growth promoting agent. It has no known toxicity or pathogenicity to any plant or animal.

The present invention involves phytobial remediation using self-organizing systems. Bioremediation typically can be defined as the use of a microbial agent to degrade or otherwise remove a toxicant from soil and usually requires the use of glucose or other nutrient source to enhance the growth of the organism. Phytoremediation typically can be defined as the use of a plant to degrade or remove a toxicant from soil and usually does not contain defined or managed root-microbial populations. Phytobial remediation, as encompassed by the present invention, is a unique concept that combines the best of bioremediation and phytoremediation. It can be defined by its component parts which include the following:

(1) A plant that grows, or can be caused to grow, in a site polluted by environmental toxicants; either water or soil, or both, in the site may be contaminated. Toxicants may include any environmental hazard, including, but not limited to, heavy metals, arsenic, polycyclic aromatic hydrocarbons, cyanide and metallocyanides, phenolic compounds, nitrates, and the like. Examples of plants that may be useful in the present invention include ferns, conifers, dicots, and monocots.

(2) A rhizosphere competent organism or a group of rhizosphere competent organisms. The organism, which preferably is not toxic or pathogenic, acquires its nutrition from the plant. In the preferred embodiment of the invention, the organism colonizes all parts of the subterranean plant roots.

Examples of useful plant-organism systems of the present invention that exhibit self-organizing features typical of phytobial remediation include leguminous plants (e.g., bean plants) plus Rhizobium or Bradyrhizobium and similar genera capable of forming nodules (irrespective of whether or not nitrogen fixation occurs); plants plus appropriate ecto- or endomycorrhizal fungi, and plants plus opportunistic plant symbionts such as fungi in the genus Trichoderma and rhizobacteria such as members of the genera Pseudomonas, Bacillus, Rhizobium, Bradyrhizobium, and Enterobacter.

As a consequence of the development of a plant-organism system of the present invention, one or more of the following occurs.

In one aspect of the present invention, root development of the plant is enhanced, resulting in a greater root mass and depth of rooting. Consequently, the level of thoroughness of root exploration of the soil is increased and soil spaces between roots is lessened. The combination of thoroughness of root exploration and greater root depth results in more efficient, deeper, and more complete removal or degradation of toxicants from soil or water.

In another aspect of the present invention, uptake of toxic elements or other toxic factors into the plants is enhanced by phytobial remediation, and plants can be harvested and the toxic materials thus removed from soil more efficiently than with phytoremediation used alone. For example, Trichoderma spp. in a phytobial system of the present invention can increase the uptake and concentration of a variety of nutrients, including without limitation, copper, phosphorus, iron, manganese, and sodium in roots in hydroponic culture, even under axenic conditions (Yedidia et al., “Effect of Trichoderma harzianum on Microelement Concentrations and Increased Growth of Cucumber Plants,” Plant and Soil 235:235-242 (2001), which is hereby incorporated by reference in its entirety). This increased uptake indicates an improvement in plant active-uptake mechanisms. Moreover, maize generally responds to nitrogen-containing fertilizers by increases in leaf greenness, growth, and yield up to a plateau that is generally considered to be the maximum for specific genotypes under the prevalent field conditions. However, plants that are grown from seeds treated with T-22 have been found to give maximum yields with as much as 40% less nitrogen-containing fertilizer than similar plants that were not treated with T-22 (Harman, G. E., “The Myths and Dogmas of Biocontrol. Changes in Perceptions Based on Research with Trichoderma harzianum T-22,” Plant Disease 84:377-393 (2000); Harman, G. E., in “Proceedings of International Symposium on Biological Control of Plant Diseases for the New Century—Mode of Action and Application Technology,” (eds. Tzeng & Huang, 71-84, National Chung Hsing Univ., Taichung City (2001); Harman et al., in “Enhancing Biocontrol Agents and Handling Risks,” eds. Vurro, M., et al., 114-125, IOS Press, Amsterdam (2001), which are hereby incorporated by reference in their entirety). Moreover, yields can increase above the yield plateau when additional nitrogen-containing fertilizer (e.g., ammonium nitrate) is used. These data show that T-22 increased the efficiency of nitrogen-containing fertilizer use by maize. This ability to reduce nitrate pollution of ground and surface water, which is a serious adverse consequence of large-scale maize culture, is another aspect of the present invention. In addition to effects on the efficiency of nitrogen use, analyses indicate that the organism causes a generalized increase in the uptake of many elements, including arsenic, cobalt, cadmium, chromium, nickel, lead, vanadium, magnesium, manganese, copper, boron, zinc, aluminum, and sodium. In most cases, however, the increase is small in typical agricultural systems. Finally, T-22—and probably other Trichoderma spp.—can solubilize various plant nutrients, such as rock phosphate, iron, copper, manganese, and zinc, that can be unavailable to plants in certain soils (Altomare et al., “Solubilization of Phosphates and Micronutrients by the Plant-Growth Promoting and Biocontrol Fungus Trichoderma harzianum Rafai,” Appl. Environ. Microbiol. 2926-2933 (1999), which is hereby incorporated by reference in its entirety). T-22 reduces oxidized metallic ions to increase their solubility and also produces siderophores that chelate iron (Altomare et al., “Solubilization of Phosphates and Micronutrients by the Plant-Growth Promoting and Biocontrol Fungus Trichoderma harzianum Rafai,” Appl. Environ. Microbiol. 2926-2933(1999), which is hereby incorporated by reference in its entirety). The phytobial remediation system of the present invention includes the abilities described herein for uptake and solubilization of nutrients and pollutants from soil and water, and, in one aspect of the present invention, results in the increased efficiency of nitrogen-containing fertilizer used on crop plants.

In one aspect of the present invention, the activities of the organisms on plant roots enhance the degradation of toxic materials such as cyanide or its metallic derivatives or polycyclic aromatic hydrocarbons, as shown in Examples 5 and 6, below. The organisms utilize substrates from roots as nutrient sources. Such systems are preferred over standard microbial remediation since (a) organisms are known that form very reliable and complete root colonization, thus avoiding the difficulties of maintaining specific microbial communities in a nutrient-enriched soil and (b) many of the root colonizing organisms are strongly resistant to a variety of toxic materials and have strong abilities to degrade toxic materials to less toxic or nontoxic forms.

The fact that the microbial agent is on roots also provides a delivery system for the organism deep into the soil profile in an active form. The complete root colonization by T22 and similar organisms causes the organism to be located as deeply in the soil profile as roots penetrate, up to several meters below the soil surface. Other methods, for example, simple irrigation of spore solutions, may also permit deep penetration of soils, but the spores in this situation will lack plant nutrients and, therefore, will be inactive (Lockwood, J. L., “Fungistasis,” Biol. Rev. 52:1-43 (1977), which is hereby incorporated by reference in its entirety). However, the principle of co-metabolism that is implicit in the phytobial remediation system of the present invention overcomes this problem since the roots provide a constant source of nutrients to the organism.

In its most preferred embodiment, the phytobial remediation system of the present invention using rhizosphere competent or biocontrolling Trichoderma strains has a number of advantages for remediation of pollutants. The plant-organism system (a) is self-organizing and robust in that it reliably colonizes plant roots and grows with them over an extended period of time, at least months; (b) co-metabolizes to give a synergistic system that results in proliferation of the fungus and enhances growth of the plant, and (c) permits the production of enzymes that degrade organic pollutants such as cyanide and polycyclic aromatics and/or allows uptake into the organism followed by degradation, e.g., of metallocyanides. In addition, with T. harzianum strain T22 there are no reported cases of pathogenicity or toxicity to any organisms other than plant pathogenic organisms. It is registered with the US EPA and has an exemption from residue tolerance, which means that its expected toxicity is of a very low level.

The lack of adverse effects and the ability to stimulate plant growth are not universal among Trichoderma spp. For example, Ousley et al. showed that some strains enhance growth of lettuce or flowering shoots, but that others can inhibit plant growth (Ousley et al., “Effect of Trichoderma on Plant Growth: A Balance Between Inhibition and Growth Promotion,” Microbial. Ecol. 26:277-285 (1993); Ousley et al., “The Effects of Addition of Trichoderma Inocula on Flowering and Shoot Growth of Bedding Plants,” Sci. Hort. Amsterdam 59:147-155 (1994), which are hereby incorporated by reference in their entirety). Thus, the present invention is directed to strains that enhance plant growth, with particular emphasis on root growth and on strains that have sufficient rhizosphere competence to be a microbial component of phytobial remediation.

In practicing all aspects of the present invention, the organism may be prepared in a formulation containing organic or inorganic materials that aid in the suspension or delivery of the organism to the recipient plant or plant seed. Furthermore, in all aspects of the present invention described herein, application of the organism(s) to a plant, seed, or other plant material may be carried out either simultaneously with the introduction of the plant, seed, or other plant propagative material into-the environmental area to be remediated or detoxified, or prior to the introduction into the area, while the plant, seed or other plant material is being established (propagated) in a greenhouse or field environment. Regardless of the order that application and introduction are carried out, the following are all suitable methods in accord with the present invention for bringing the organism and plant material of choice in contact.

Incorporation into soils or greenhouse planting mixes. Beneficial organisms may be formulated or mixed to prepare granules, dusts, or liquid suspensions. These can be mixed directly into soils or planting mixes. The preparations are then mixed into the soil or planting mix volume for greenhouse applications or into the upper volume of field soil (Harman, G. E., “The Myths and Dogmas of Biocontrol. Changes in Perceptions Based on Research with Trichoderma harzianum T-22,” Plant Disease 84:377-393 (2000), which is hereby incorporated by reference in its entirety). Equipment and procedures for such applications are well known and used in various agricultural industries. Typical rates are 0.2 to 10 kg of product containing 10⁷ to 10⁹ colony forming units (cfu) per cubic meter of planting mix or soil.

Drenches for greenhouse or nursery soils and soil mixes. Liquid suspensions of the beneficial microorganisms can be prepared by mixing dry powder formulations into water or another carrier, including fertilizer solutions, or by diluting a liquid formulation containing the organism in water or other aqueous solutions, including those containing fertilizers. In either case, the formulation may include other organic or non-organic additives to aid in dissolving or applying the mixture. Solutions can then be used to water planting mixes either prior to planting or else when plants are actively growing, such as by field irrigation. Typically 10 to 400 ml of product (typically 150 μm or smaller in particle size) containing 10⁷ to 10⁹ cfu are mixed with 100 L of water for such applications.

Slurry, film-coated or pelleted seeds. Seeds are commonly treated using slurry, film-coating or pelleting by processes well known in the trade (Harman et al., “Factors Affecting Trichoderma hamatum Applied to Seeds As a Biocontrol Agent,” Phytopathology 71:569-572 (1981); Taylor et al., “Concepts and Technologies of Selected Seed Treatments,” Ann. Rev. Phytopathol. 28: 321-339 (1990), which are hereby incorporated by reference in their entirety). The beneficial microbial agents of the present invention can effectively be added to any such treatment, providing that the formulations do not contain materials injurious to the beneficial organism. Depending on the organism in question, this may include chemical fungicides. Typically, powder or liquid formulations (10⁷ to 10¹⁰ cfu/g) of the organism are suspended in aqueous suspensions to give a bioactive level of the organism. The liquid typically contains adhesives and other materials to provide a good level of coverage of the seeds and may also improve its shape for planting or its cosmetic appeal.

Dust or planter box treatments for roots, bulbs, and seeds. Dry powders containing beneficial organisms can be applied as a dust to roots, bulbs or seeds. Generally fine powders (usually 250 μm or smaller) are dusted onto seeds, bulbs or roots to the maximum carrying powder (i.e., until no more powder will adhere to the treated surface). Such powders typically contain 10⁷ to 10⁹ cfu/g.

Application by injection. Liquid suspensions of products may be injected under pressure into the root zone of appropriate plants through a hollow tube located at the depth desired by the application. Equipment for such application is well known in the horticulture industry. Alternatively, suspensions or powders containing appropriate organisms can be applied into wells or other aqueous environments in the soil.

In-furrow application. Liquid suspensions of products may be prepared as described above for preparing drenches. Such materials may be added to the furrow into which seeds are planted or small plants are transplanted. Equipment for such applications is widely used in the agricultural industry. Typical rates of application are 0.5 to 10 kg of product (10⁷ to 10⁹ cfu/g) per hectare of field.

Broadcast applications. Granules, as described above, can be broadcast onto soil surfaces that contain growing plants, to soil at the time of planting, or onto soils into which seeds or plants will be planted. Typical rates range from 1 to 500 kg of product containing 10⁷ to 10⁹ cfu/g depending upon the plants to be treated and the goals of the treatment. Alternatively, spray solutions can be prepared as described above, and applied to give similar rates (Harman, G. E., “The Myths and Dogmas of Biocontrol. Changes in Perceptions Based on Research with Trichoderma harzianum T-22,” Plant Disease 84:377-393 (2000); Lo et al., “Biological Control of Turfgrass Diseases with a Rhizosphere Competent Strain of Trichoderma harzianum,” Plant Disease 80:736-741(1996); Lo et al., “Improved Biocontrol Efficacy of Trichoderma harzianum 1295-22 for Foliar Phases of Turf Diseases By Use of Spray Applications,” Plant Disease 81:1132-1138 (1997), which are hereby incorporated by reference in their entirety).

For the purposes of the present invention, all treatments are designed to accomplish the same purpose, i.e., to provide a means of application that will result in effective colonization of the root by the beneficial organism (Harman et al., “Potential and Existing Uses of Trichoderma and Gliocladium For Plant Disease Control and Plant Growth Enhancement,” In Trichoderma and Gliocladium, Harman et al., eds., Vol. 2, London:Taylor and Francis (1998), which is hereby incorporated by reference in its entirety). In addition, treatments may be used to direct the microbial products directly into the polluted soil or water to be treated.

The methods of the present invention can be utilized to treat a wide variety of plants or their seeds. Suitable plants include ferns, conifers, monocots, and dicots. More particularly, usefull monocots include, without limitation, rice, wheat, grass, maize, or sorghum. Useful dicots include, without limitation, cotton, bean plants, any Brassica spp., corn, trees, and shrubs.

Phytobial remediation overcomes many of the limitations cited above that have plagued bioremediatory and phytoremediatory approaches to alleviation of soil and water pollution. It enhances plant root growth and generally increases plant biomass. Thus, it has great potential for enhancement of phytoremediation. Since it enhances phytoremediation and accomplishes bioremediation simultaneously, it has the ability both to remove polluting toxic elements and degrade toxic compounds. Sites that contain both types of pollutants are common, thus a highly versatile system will be preferred to more limited ones.

Products based on strain T22 are becoming fairly widely used in rock wool and even fully hydroponic systems for production of plant products. Therefore, one aspect of the present invention includes plants grown in blocks of rock wool or another porous substrate, where aqueous plant nutrients are pumped in the system in an ebb-and-flow system (oscillating levels of nutrient solution). T22 is added as a granular or liquid suspension to the rock wool, or other porous support or matrix, where it comes into contact with, colonizes, and grows with plant roots. Nutrients typically are used more efficiently and plants provide greater yields in the presence of T22 than in its absence. This is strong evidence of enhanced rhizofiltration capabilities of the plants in association with the fungus. Polluted water, potentially containing toxic substances, can be passed through the porous support. The plants will take up one or more of the toxic substances, thereby removing the toxic substance from the polluted water. The toxicant is then removed from the polluted area by removing the plants that have taken up toxic substances. In this aspect of the present invention toxicants may include any environmental hazard, including, but not limited to, heavy metals, arsenic, selenium, chromium, cadmium, lead, boron, copper, zinc, cyanide, metallocyanides, tritium, mercury, manganese, magnesium, aluminum, nickel, and vanadium, polycyclic aromatic hydrocarbons, cyanide and metallocyanides, phenolic compounds, nitrates, and the like. Examples of plants that may be useful in this aspect of the present invention include ferns, conifers, dicots, and monocots.

In another aspect of the present invention, fungi alone are added to a porous matrix, such as described above, and polluted water, potentially containing one or more toxic substances, is passed through the solid support, allowing the fungi to take up and/or degrade the pollutants to a non-toxic or non-polluting form, thus removing the pollutant from the water. In this aspect of the present invention suitable fungi include all those described above, preferably rhizosphere competent species, and the pollutant maybe any described above, including, without limitation, nitrates or nitrites, phosphorus, potassium, iron, arsenic, nickel, lead, zinc, mercury, aluminum or copper.

In yet another aspect of the present invention, fungi and bacteria are introduced to a polluted area, either water or soil or a combination thereof, with or without subsequent aeration, under conditions effective to allow the fungi to grow and-take up pollutants, including non-toxic substances and toxicants, in the environment. All fungi and bacteria named herein, or combinations thereof, are suitable in this aspect of the present invention, (e.g., Trichoderma spp.,) and including mushrooms, for example, Pleurotis spp., and Agaricus spp. In this aspect of the present invention, the fungi are capable of removing, by uptake or degradation, a simple or complex phenolic pollutant, cyanide or a metallocyanide. This aspect of the present invention is also suitable for remediation of soils polluted with polycyclic aromatic hydrocarbons and similar materials from the petroleum industry.

The examples that follow illustrate the utility of this invention.

### EXAMPLES

### Example 1

### Increased Root Hair Formation by Plant Roots in the Presence of T. harzianum strain T22

As noted earlier, Trichoderma strains, particularly T. harzianum strain T22, can increase root development, including promoting greater root density and depth. These are important contributions to self-organizing phytobial systems, but omits a key part of the system. Plant nutrients and other materials are taken up through or by fine roots and root hairs, therefore, the numbers and the proliferation of these structures are critically important.

In these experiments, maize plants (inbred line Mo17) were grown with or without T. harzianum treatment for five or ten days, and analyzed for root and shoot size, root hair area, and root length.

For assays that continued for only five days, 10 ml deionized water was placed in a 3×11×11 cm plastic box and a seed germination blotter 11×11 cm was placed in the liquid. Ten seeds with or without T22 treatment were placed in the boxes. Moist Arkport sandy loam field soil infested or not infested with P. ultimum (Harman et al., “Interactions Between Trichoderma harzianum Strain T22 and Maize Inbred Line Mo 17 and Effects of This Interaction on Diseases Caused by Pythium ultimum and Colletotrichum graminicola,” Phytopathology 94:147-153 (2004), which is hereby incorporated by reference in its entirety) was used to fill the box to a depth of 2 cm; the inoculum level used was sufficient to cause 50-80% mortality of cucumber seeds, which was used a measure of inoculum potential (Harman et al., “Interactions Between Trichoderma harzianum Strain T22 and Maize Inbred Line Mo17 and Effects of This Interaction on Diseases Caused by Pythium ultimum and Colletotrichum graminicola,” Phytopathology 94:147-153 (2004), which is hereby incorporated by reference in its entirety). Another sheet of moist blotter paper was added to the surface of the soil and the box was covered with a fitted plastic lid to prevent moisture loss. Boxes were incubated for 5 days at 25° C. and seedlings were removed for further analysis. Each experiment was conducted in triplicate and data was analyzed using Fisher's Protected LSD test (SuperAnova, Berkeley, Calif.).

Ten-day assays were conducted in larger boxes (5×11×11 cm). Four or five seeds, either treated or not treated with T22, were planted in each box and plants were grown for various lengths of time with 12 hr diurnal fluorescent lighting and were watered as needed. In some experiments, soils were autoclaved to examine maize growth responses in the absence of natural soil pathogens. In addition, some soils were drenched with mefenoxam ((R)-2-[2,6-dimethylphenyl)-methoxyacetylamino]-propionic acid methyl ester]; Subdue MAXX, Novartis, Research Triangle, NC) according to the manufacturer's directions.

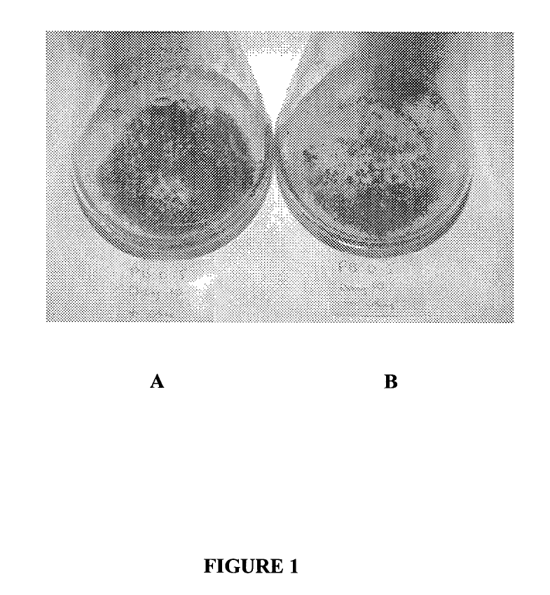

In some experiments, plants were removed from soil, and shoot and root growth were examined in detail. Plants were removed from soil, adhering soil was rinsed away, and the final residual soil adhering to the root hair regions removed carefully by stroking with a small paint brush. The plants were immersed in 0.02% (w/v) thionin in deionized water, which resulted in light blue staining of the root system. The stained plants then were placed in water and scanned (Hewlett Packard 4C/T ScanJet), and the images stored in electronic memory. Images were analyzed using MacRhizo 3.8 software (Regent Instruments, Quebec City, Quebec). With the stained roots, the root hair region appeared as a light gray fringe adjacent to black root images. Changes in the threshold settings in the software allowed measurement of only the black root areas and separately of the black root plus the gray fringe of root hairs, as shown in FIG. 1. From this data, the area of root hairs on each root system could be calculated as the difference between the two measurements. Areas, lengths, and volumes of total and different size classes of roots also were quantitated using the MacRhizo software, as well as areas and lengths of shoots.

Data analysis considered each individual plant as a replicate and experiments consisted of fifteen to thirty plants per treatment in each experiment. Mean values for each treatment were analyzed by LSD (SuperAnova) tests to give probability values.

Effects of T22 and P. ultimum on root and shoot size and root hair area. Seedlings of Mo 17 produced from T22-treated seeds had larger roots and shoots than similar seedlings in the absence of T22, as shown in Table 1, below. Root systems from T22-treated seeds were nearly twice as long as those from control plants and growth of both fine and main roots were similarly enhanced (Table 1). Root areas also were measured and are proportional to root length, so the total area and volume of roots in the presence of T22 also were about twice that of check plants. Root hair area also increased in the presence of T22 (Table 1), but the root hair area per unit root length was greater in control plants than with those from T22 (Table 1). These differences could be noted in 5-day-old seedlings (Table 1) and persists into larger plants (Harman et al., “Interactions Between Trichoderma harzianum Strain T22 And Maize Inbred Line Mo 17 and Effects of This Interaction on Diseases Caused by Pythium ultimum and Colletotrichum graminicola,” Phytopathology 94:147-153 (2004), which is hereby incorporated by reference in its entirety).

TABLE 1
Effects of T22 on shoot and root size and root parameters
ten days after planting in a sandy loam field soil.

| | | Total | Fine | Main | | Ratio root |
|---|---|---|---|---|---|---|
| | Shoot | Root | root | root | Root hair | hair |
| | length | length | length | length | area | area/root |
| Treatment | (cm) | (cm) | (cm) | (cm) | (cm²) | length |
| None | 4.5 | 28 | 11 | 17 | .88 | 0.031 |
| T22 | 7.0 | 51 | 22 | 29 | 1.3 | 0.025 |

In this experiment 30 treated and 30 untreated plants were measured. Each plant was considered a separate experimental unit and values are means across the 30 plants. All comparisons are significant at P = 0.05 by T tests. Shoot length was measured by ruler but all other measurements were made using MacRhizo software following scans of the root system.

However, as noted earlier, T22 substantially increases plant growth. Whether the increase measured in Arkport sandy loam field soil was a biocontrol or a direct effect upon the plant was also investigated. Treatment of field soil with mefenoxam (Subdue Maxx), which primarily controls pythiacous Oomycetes, or autoclaving tended to increase growth of Mo17, shown in Table 2, below. However, seed treatments with T22 increased plant growth more than either soil treatment. Further, T22 also increased shoot growth in plants grown in mefenoxam-treated or untreated soil, which suggests that control of soil microflora was not the only mechanism by which T22 increased Mo 17 seedling growth. Table 2 shows the effects of soil treatments and seed treatments with T22 on shoot length of Mo17 seven days after planting in Arkport sandy loam field soil.

TABLE 2

| Seed treatment | Fungicide soil treatment | Shoot length (mm) |
|---|---|---|
| None | None | 58a x |
| T22 | None | 85bc z |
| None | mefenoxam | 63ab xy |
| T22 | mefenoxam | 96c z |
| None | Autoclaving | 79abc xy |
| T22 | Autoclaving | 92c z |

Plants were grown in boxes and four seeds were planted per box. Each plant was considered an experimental unit and there were 12 plants per treatment. Seeds were treated or not treated with T22 and/or soils were either drenched or not with mefenoxam or else autoclaved or not for 90 minutes. Numbers followed by the same letter are not significantly different at P = 0.05 (a-c) or P = 0.1 (x-z) by Fisher's Protected LSD test.

### Example 2

### Enhanced Root and Plant Biomass Development Using Two Microbial Agents

In many cases, multiple root enhancing agents may be beneficial. In this example, soybean seeds were treated either with commercial formulations of T. harzianum T22, the nitrogen-fixing bacterium Bradyrhizobium japonicum, with both organisms, or left untreated. They were planted in a sandy loam field that contained a low endogenous level of nitrogen (10 ppm of nitrate at the time of planting). Some plots of each treatment received a side dressing of ammonium nitrate to give a level of 80 kg/ha. Since Bradyrhizobium fixes nitrogen, any plants without N fertilizer were deficient in this nutrient, but with added N fertilizer none had obvious nitrogen deficiency symptoms. At the end of the season (approximately three months after planting) a back hoe was used to dig plants from the various treatments and the sandy loam soil was carefully removed. Roots were scanned and root lengths and surface areas were quantitated using MacRhizo software.

It should be noted that the results are from a seed treatment and were measured several months after application. This information, as well as other data (U.S. Patent Application Publication No. US2002/0103083 A1 to Harman; Harman, G. E., “The Myths and Dogmas of Biocontrol. Changes in Perceptions Based on Research with Trichoderma harzianum T-22,” Plant Disease 84:377-393 (2000), which are hereby incorporated by reference in their entirety), indicates that the effects of T22 on plants are long-term and are a consequence of the self-organizing capability known as rhizosphere competence.

Data on root development of plants with added nitrogen fertilizer is directly comparable, since nitrogen limitation did not occur significantly between treatments. Table 3, below, provides data on total root length, length of fine roots (which had the greatest absorptive capabilities), and total root surface area. The abbreviation Bj indicates B. japonicum.

TABLE 3
Root parameters with adequate nitrogen fertilizer

| | Total root length/ | Length of fine | Total root area/plant |
|---|---|---|---|
| Treatment | plant (cm) | roots/plant (cm) | (cm²) |
| None | 26a | 462a | 112a |
| T22 | 831ab | 589ab | 150b |
| Bj | 867b | 672b | 146ab |
| T22 + Bj | 1042b | 770b | 178b |

Numbers followed by the same letter are not significantly different at P = 0.05.

These data clearly show the enhancement of root growth of soybeans at adequate nitrogen levels by both T22 and B. japonicum that is most evident when both organisms are present. For example, total root lengths are about 67% (increase of root length/root length of check) greater on plants that grew from seeds treated with both organisms as compared with no seed treatment. Again, it should be emphasized that only a very small amount of either organism was applied to the seeds at planting and that the long-term effect noted above was a consequence of the growth of both organisms on the root surface (T22) or in nodules on the roots (B. japonicum). Both organisms possess self-organizing abilities to colonize roots that are a necessary prerequisite for these types of effects.

This work demonstrating that T22 and B. japonicum enhance root growth adds to existing information on the benefits of combinations of Trichoderma spp. Chakraborty (Chakraborty, “Protection of Soybean Root Rot by Bradyrhizobium japonicum and Trichoderma harzianum, Associated Changes in Enzyme Activities and Phytoalexin Production,” J Mycology and Plant Pathology 33:21-25 (2003), which is hereby incorporated by reference in its entirety), reported that a seed treatment with B. japonicum or a soil treatment with T. harzianum reduced root rot of soybean caused by Fusarium oxysporum but that the combination gave the most significant-disease reduction. Similarly, Ehteshamul (Ehteshamul et al., “Role of Bradyrhizobium and Trichoderma spp. in the Control of Root Disease of Soybean,” Acta Mycol. 30:35-40 (1995), which is hereby incorporated by reference in its entirety) reported that seed treatments with B. japonicum, T. harzianum, T. viride, T. hamatum, T. koningii and T. pseudokoningii significantly controlled infection of 30-day old seedlings by Macrophomina phaseolina, Rhizoctonia solani and Fusarium spp. On 60-day old plants the use of B. japonicum together with T. harzianum, T. viride, T. koningii and T. pseudokongii controlled infection by M. phaseolina. The combination of T. hamatum and B. japonicum resulted in increased soybean yield.

However, as noted earlier, similar experiments were carried out with soybeans in soils without residual nitrogen. Quite different results were obtained, as noted in Table 4, below.

TABLE 4
Root parameters without adequate nitrogen fertilizer

| | Total root length/ | Length of fine | Total root area/plant |
|---|---|---|---|
| Treatment | plant (cm) | roots/plant (cm) | (cm²) |
| None | 1331b | 1029b | 220b |
| T22 | 858a | 611a | 157a |
| Bj | 724a | 526a | 132a |
| T22 + Bj | 855a | 620a | 165a |

Numbers followed by the same letter are not significantly different at P = 0.05.

At insufficient nitrogen levels, soybeans produce relatively large quantities of roots, presumably in quest of nitrogen fertilizer. However, this response is much less in the presence of T22, and, in fact, root development of soybeans in the presence of T22 is quite similar at both adequate and low levels of N. Of course, with B. japonicum, N stresses are much less since nitrogen fixing occurs.

Nitrogen stress in the absence of T22 results in much smaller plants that yield less. In the context of the present invention, this is very undesirable. For example, phytoextraction relies largely on a large plant biomass into which toxic materials are translocated (i.e., the amount of toxicants removed from soil or water is the-product of the concentration of materials taken up into the plant-times the biomass of the plants). Thus, treatments that increase or decrease biomass will affect the success of the phytoextraction treatment. Moreover, translocated photosynthate from shoots to roots is the primary source of nutrition for plant symbiotic organisms such as T22 or B. japonicum. An adequate supply of nutrients (photosynthate) is critical for production of enzymes necessary for the enzymatic degradation and detoxification of pollutants as noted in later examples. Thus, treatments that improve overall plant health and vigor are likely to improve the success of remediatory strategies implicit in the present invention.

In the present example, the culmination of the soybean life cycle is the production of beans. Therefore, yield is an important factor predicting success of microbial inoculants in either the agricultural or remediation sector. Yields of beans are given in Table 5, below.

TABLE 5
Soybean yields at two N levels and various microbial seed treatments

| | Yield at adequate N levels | |
|---|---|---|
| Treatment | (Kg/Ha) | Yields at low N levels (Kg/Ha) |
| None | 2880a | 1740a |
| T22 | 3120ab | 2280ab |
| Bj | 3600b | 2640bc |
| Bj + T22 | 3660b | 3000c |

Numbers within columns with the same letter are not significantly different at P = 0.05.

These data demonstrate that even though the soybeans at low N levels had larger roots, the above-ground plant weight was reduced. Thus, the added root exploration and volume in the absence of beneficial organisms and low levels of available N was detrimental to the final yield of the plant. Conversely, in the presence of the beneficial organisms and adequate N levels, yields are increased, as was root length and surface area. Thus, microbial stimulation of root development is positively associated with improved biomass production while the stimulation driven by low nitrogen levels was negatively associated with biomass.

These data clearly show that root-associated microflora including T22 and B. japonicum can increase root development, that combining these two organisms tends to be more beneficial than either one alone, and that the stimulation of root growth increases plant biomass. This is consistent with data on several other plants including maize (Harman, G. E., “The Myths and Dogmas of Biocontrol. Changes in Perceptions Based on Research with Trichoderma harzianum T-22,” Plant Disease 84:377-393 (2000); U.S. Patent Application Publication No. US2002/0103083 A1 to Harman, which are hereby incorporated by reference in their entirety), that suggests that this phenomenon is broadly applicable across both monocots and dicots.

### Example 3

### Increased Uptake of Nutrients or Toxicants in Plants by Trichoderma spp.

Other research has shown that T. harzianum strain T-203 in an axenic hydroponic system enhanced uptake of zinc, phosphorous, iron, manganese, and sodium into roots and that levels of zinc, phosphorous, and manganese increased in shoots (Yedidia et al., “Effect of Trichoderma harzianum on Microelement Concentrations and Increased Growth of Cucumber Plants,” Plant and Soil 235:235-242 (2001), which is hereby incorporated by reference in its entirety). This information suggests that T-203, which is rhizosphere competent, enhances uptake of some plant nutrients. Moreover, Harman presented evidence that the robust association of T22 with maize roots can improve nitrogen uptake in the plant. However, none of these disclosures address enhancement of phytoextraction of some of the more important elemental toxicants such as arsenic, chromium, lead, cadmium, and others (Harman, G. E., “The Myths and Dogmas of Biocontrol. Changes in Perceptions Based on Research with Trichoderma harzianum T-22,” Plant Disease 84:377-393 (2000), which is hereby incorporated by reference in its entirety).

In the course of research on agronomic potentials of T22, maize was grown with and without the organism in the field (Harman, G. E., “The Myths and Dogmas of Biocontrol. Changes in Perceptions Based on Research with Trichoderma harzianum T-22,” Plant Disease 84:377-393 (2000); U.S. Patent Application Publication No. US2002/0103083 A1 to Harman, which are hereby incorporated by reference in their entirety). However, the plants were also analyzed for accumulation of various elements. These plants were grown on a sandy loam soil without high levels of the toxicants noted below. It was anticipated that differences between T22-colonized and noncolonized roots with hyperaccumulating plants on polluted sites would be more dramatic. Results in the Table 6, below, are on a plant dry weight basis.

TABLE 6
PPM in plant tissues

| Element | Without T22 | With T22 |
|---|---|---|
| Cobalt | 0.17 a | 0.26 b |
| Cadmium | 0.16 a | 0.24 a |
| Chromium | 2.2 a | 2.4 a |
| Nickel | 0.91 a | 1.0 a |
| Lead | 1.1 a | 1.3 a |
| Vanadium | 0.43 a | 0.51 a |
| Arsenic | 0.66 a | 1.1 b |
| Magnesium | 1570 a | 1640 a |
| Manganese | 17 a | 19 a |
| Copper | 3.39 a | 3.40 a |
| Boron | 4.4 a | 4.6 a |
| Zinc | 15.5 a | 15.7 a |
| Aluminum | 16.5 a | 18 a |
| Sodium | 29.5 a | 38.1 b |

Numbers followed by similar letters for each element are not significantly different at P = 0.05.

These data demonstrate that, in the case of every element, the concentration in maize increased numerically, although in some cases, such as magnesium, the increase was quite small. In only a few cases, such as arsenic and cobalt, were the differences significantly different at P=0.05. These results are to be expected since maize is not a hyperaccumulator of these elements and these typical agricultural soils did not contain unusually high levels of any of these.

Nonetheless, these data strongly suggest that, overall, T22 increases accumulation of most elements into plants. This would be expected given the increase in root hairs and root sizes associated with the overall T22 effect. It is anticipated that these effects will be magnified several-fold with a proper choice of hyperaccumulating plants that respond strongly to the root-associated symbionts.

### Example 4

### Degradation of Cyanide by Trichoderma spp. in Association with Plants

A recent paper indicates that cyanide is degraded by extracellular constitutively expressed enzymes produced by Trichoderma spp. (Ezzi et al., “Cyanide Catabolizing Enzymes in Trichoderma spp.,” Enz. Microb. Technol. 6191:1-6 (2002), which is hereby incorporated by reference in its entirety). Two separate enzymes are produced, i.e., cyanide hydratase and rhodanese. Several different Trichoderma strains were examined and all expressed the enzymes.

Further, it has been demonstrated that T. harzianum WT catabolized toxic levels of free cyanide in association with lettuce plants (Latuca sativa) (European Patent Application Serial No. EC 0128180.7, which is hereby incorporated by reference in its entirety). A different microcosm assay has now been used. Cyanide was added at concentrations of 50 ppm and 100 ppm to a sandy loam soil. T. harzianum IMI 275950 or T12 grown on a bran-sand mixture was added to the soil at the 4% w/w and uniformly mixed. The soil (200 g) was added to a cylinder formed from an A4-sized transparency sheet rolled to fit in a Petri-plate at the bottom. Five seeds of either pea (Pisum sativum) or wheat (Triticum aestivum) were added to each microcosm. There was no seed germination in any of the microcosms unless either of the Trichoderma strains were added to the soil. With the fungus present, plant growth was normal. The fungi had the capacity to catabolize the cyanide using cyanide hydratase and rhodanese enzymes as noted in Ezzi et al., “Cyanide Catabolizing Enzymes in Trichoderma spp.,” Enz. Microb. Technol. 6191:1-6 (2002), which is hereby incorporated by reference in its entirety.

However, even though the systems above describe a mixture of seeds and organisms, it does not include a phytobial system. None of the strains noted above are rhizosphere competent and are therefore incapable of establishing the persistent self-organized system required to meet the phytobial system as defined. However, it has now been demonstrated that T. harzianum strain T22, which is capable of establishing long-term root colonization, also expresses these enzymes and is expected to degrade cyanide when applied in combination with plants. This provides a unique and long-lasting cyanide-degrading system adapted to diverse plants and soils. This capability dramatically extends the utility of EC 0128180.7 to environments and time scales not possible without the phytobial systems. Therefore, another aspect of the present invention is a method of degrading toxic substances taken up by the phytobial or microbial system of the present invention to a less toxic or nontoxic form.

Recently, a variety of willow was discovered that was capable of taking up and degrading cyanides and metallocyanides (Ebbs et al., “Transport and Metabolism of Free Cyanide and Iron Cyanide Complexes by Willow,” Plant Cell Environ 26:1467-1478 (2003), which is hereby incorporated by reference in its entirety). Such willow shrubs or trees will form highly effective remediation systems either used or combined with synergistic root colonizing microbes. Thus, a preferred embodiment of the present invention is the use of trees or shrubs that take up and degrade toxicants, either used alone or in combination with synergistic microbes.

### Example 5

### Accumulation and Degradation of Metallocyanides by Trichoderma spp. in Association with Plants

Ten wheat seeds were germinated in petri dishes containing approximately 50 g of grit sand. Each dish was moistened with plant nutrient solution in the presence or absence of 15000 ppm metallocyanide Prussian blue. Prussian blue is a mixed oxidation state iron organic complex in which the most common component is Fe₄ [Fe(CN)₆]₃. The Prussian blue caused a reduction in mean root length of the wheat seedlings from 4.5 cm to 2.0 cm, but where T. harzianum T22 was added to the dishes, the average root length of the germinated seedlings was 4.0 cm. This proved that the fungus is capable of protecting plants from the toxic effect of the metallocyanide. It is anticipated that this protection is due to the uptake of the metallocyanide into the fungus, whereafter it is degraded to nontoxic products, as shown in FIGS. 1A-B.

### Example 6

### Alleviation of Toxicity of a Polycyclic Aromatic Hydrocarbon by Trichoderma spp.

Wheat agar was prepared by mixing 10 g of straw with 1 liter of mineral solution and 10 g agar. The agar was poured into petri dishes. A 5 mm square of colonized potato dextrose agar was inoculated into the center of the plate. Phenanthrene at 20 g l⁻¹ was sprayed onto half the plates. The plates were incubated at 30° C. and the fungal colony radius measured every 24 hours. For T. harzianum T12, the radial colony growth was 5.8 mm d⁻¹ (SD 0.8) but in the presence of phenanthrene there was no fungal growth. For T. harzianum T22, the radial colony growth was 22.7 mm d⁻¹ (SD 1.5), but in the presence of phenanthrene the radial extension was reduced to 16.5 mm d⁻¹ (SD 0.5). Clearly, the strain T22 is not very sensitive to the toxin. It is expected that it would also be able to do this in association with plant roots in lieu of the straw. In addition, strains T12 and T95 were parents in the asexual hybridization that was used to prepare T22, and the vast majority of the genome of T22 arises from T12 (Harman et al., “Asexual Genetics in Trichoderma and Gliocladium: Mechanisms and Implications,” In Trichoderma and Gliocladium, Kubicek et al., eds., Vol. 1. London:Taylor and Francis, p. 243-270 (1998), which is hereby incorporated by reference in its entirety). This extends phytobial systems to degradation of polycyclic aromatic hydrocarbons. Moreover, the comparison of T12 and T22, which have similar genetic composition, makes this result more surprising.

### Example 7

### Alleviation of Pollution by Phenolic Compounds in Water and in Soil

The disposal and remediation of waste water from olive oil production is a major economic and environmental problem associated with the production of oil in all areas with Mediterranean climates. In fact, a growing percentage of the price of the final oil product derives from the cost of disposal. In addition, most of these waste waters are damped in potential agricultural soil during winter (low bioremediation ability), rendering it not useful for crop production.

These waste waters are a complex tensioactive solution with high stability. The sedimentation of the suspended particles does not occur in reasonable time and simple filtration is not applicable given the dimension of the micelles. The pH is between 3 and 5, and strong odours are released due to fermentation over time. A comparison of Biological Oxygen Demand (BOD) for olive waste water with typical urban waste waters demonstrates that the processing of 1 ton of olives (corresponding to 200 L of oil) corresponds to the pollution impact of about 900 inhabitants. Mediterranean regions process about 7000 tons of oil every year. Thus, during the production of oil in the area the level of pollution is tripled.

The real problem with these waste waters is that they require an elevated amount of oxygen, which cannot be provided by the bacteria usually applied for bioremediation and because polyphenols and other compounds in the waste water are highly toxic to the bacteria. The most significant polluting components of these waste water are phenols (12.7 g/L) which include tannins (5 g/L), flavoids (1 g/L) and various simple and polyphenols (about 6 g/L). Some of these compounds are structurally somewhat similar to polycyclic aromatic hydrocarbons.

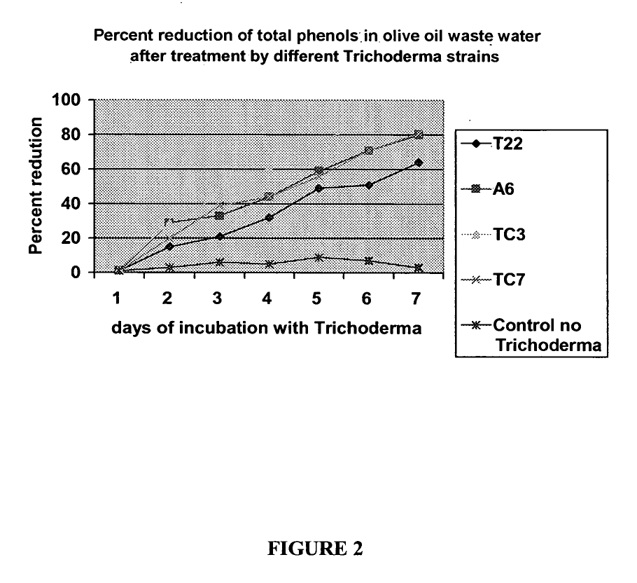

These compounds can be degraded by fungi, including edible mushrooms in the genus Pleurotis, and Trichoderma spp. Several Trichoderma strains (T22, A6, TC3, TC7) that are able to remove phenols and polyphenols from the waste waters (clearing and reduction of phytotoxic and antimicrobial effect) were tested. These strains were grown in fermenters with aeration and stirring. Biomass doubled in 24 hr in the presence of waste waters as the main carbon source after appropriate dilution. Data on removal of total phenols from these waste waters by Trichoderma spp. are shown in FIG. 2.

These data demonstrate that these fungi are capable of rapid and relatively complete removal of phenolic compounds from olive oil waste water streams. These strains also have utility for cleaning soils polluted with waste waters or other similar materials. Exhausted compost from mushroom farms, which is made of cubes of about 17 Kg of plant wastes colonized by the mushroom (Pleurotis, Agaricus, or similar genera) mycelia and their parasites (Trichoderma), is available at about 2 million cubes per year in Italy. These substrates can be used to grow agriculturally useful Trichoderma for making compost that can be directly processed for application as an agricultural amendment. In addition, these substrates can be amended with Trichoderma and/or mushroom spawn to prepare biofilters for partial or complete purification of oil waste waters.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method for remediating a polluted environmental area comprising:
providing a plant or a plant seed;
providing a fungal or bacterial organism, wherein the organism is capable of colonizing plant roots;
combining the organism with the plant or the plant seed under conditions effective for the organism to colonize the roots of the plant or a plant grown from the plant seed, thereby creating a plant-organism system; and
introducing the plant-organism system to the polluted environmental area, thereby remediating the environmental area.

2. The method according to claim 1, wherein the environmental area comprises soil.

3. The method according to claim 1, wherein the environmental area comprises water.

4. The method according to claim 3 further comprising:
introducing the plant-organism system to a porous support and
passing water through the porous support, wherein the water contains pollutants, and wherein the plant takes up and uses the pollutants, thereby removing the pollutants from the polluted water.

5. The method according to claim 1 further comprising:
providing a supplemental source of nutrients for the organism.

6. The method according to claim 5, wherein the supplemental source of nutrients is ammonium nitrate.

7. The method according to claim 1, wherein the organism is provided as a granule, dust, powder, slurry, film, or liquid suspension.

8. The method according to claim 7, wherein the organism is in a formulation further comprising an organic or inorganic material.

9. The method according to claim 7, wherein the formulation comprises water or water containing carboxymethyl cellulose.

10. The method according to claim 1, wherein said combining is carried out by broadcast application, spray application, irrigation, injection, dusting, pelleting, or coating of the plant or the plant seed, or of the environmental area with the organism.

11. The method according to claim 1, wherein said combining is carried out before the plant or the plant seed is introduced to the polluted environmental area.

12. The method according to claim 1, wherein said combining is carried out after the plant or the plant seed is introduced to the polluted environmental area.

13. The method according to claim 1, wherein the plant or plant seed is a fern, a conifer, a dicot, or a monocot.

14. The method according to claim 13, wherein the plant or plant seed is a monocot.

15. The method according to claim 14, wherein the monocot is rice, wheat, grass, maize, or sorghum.

16. The method according to claim 13, wherein the plant or plant seed is a dicot.

17. The method according to claim 16, wherein the dicot is selected from the group consisting of cotton plants, bean plants, corn plants, trees, and shrubs.

18. The method according to claim 1, wherein the organism is rhizosphere competent.

19. The method according to claim 1, wherein the organism is a plant symbiont.

20. The method according to claim 1, wherein the organism is selected from the group consisting of Trichoderma spp., Gliocladium spp., Rhizobium spp., Pseudomonas spp., Bacillus spp., and Enterobacter.

21. The method according to claim 20, wherein the organism is Trichoderma spp.

22. The method according to claim 21, wherein the organism is Trichoderma harzianum.

23. The method according to claim 1, wherein the pollutant is a toxic substance and the organism is capable of degrading toxic substances to less toxic or nontoxic forms.

24. The method according to claim 1, wherein the organism is capable of uptake of a toxic substance.

25. The method according to claim 24, wherein the toxic substance is selected from the group consisting of arsenic, selenium, chromium, cadmium, lead, boron, copper, zinc, cyanide, metallocyanides, tritium, mercury, manganese, magnesium, aluminum, nickel, and vanadium.

26. The method according to claim 1, wherein the plant roots are colonized by one or more organisms that increase plant root density and/or depth of penetration of soil volume.

27. A method for removing a toxic substance from an environmental area comprising:
providing a plant or a plant seed, wherein the plant or the plant grown from the plant seed is capable of uptake of toxic substances;
providing a fungal or bacterial organism, wherein the organism is capable of colonizing plant roots;
combining the organism with the plant or the plant seed under conditions effective for the organism to colonize the roots of the plant or of a plant grown from the plant seed, thereby creating a plant-organism system capable of the uptake of toxic substances;
introducing the plant-organism system to the environmental area;
allowing the uptake of the toxic elements into the plant; and
removing the plant from the environmental area, thereby removing the toxic substance from the environmental area.

28. The method according to claim 27, wherein the environmental area is soil.

29. The method according to claim 27, wherein the environmental area is water.

30. The method according to claim 29 further comprising:
introducing the plant-organism system to a porous support and
passing polluted water through the porous support, wherein the polluted water contains toxic substances, and wherein the plant takes up toxic substance, thereby removing the toxic substance from the polluted water.

31. The method according to claim 27, wherein the toxic substance is selected from the group consisting of arsenic, selenium, chromium, cadmium, lead, boron, copper, zinc, cyanide, metallocyanides, tritium, mercury, manganese, magnesium, aluminum, nickel, and vanadium.

32. The method according to claim 31, wherein the organism is capable of uptake and degradation of metallocyanides.

33. The method according to claim 32, wherein the organism is resistant to toxicity of metallocyanides.

34. The method according to claim 27, wherein the organism is capable of detoxifying polycyclic aromatic compounds.

35. The method according to claim 27, wherein the toxic substance is a simple or complex phenolic pollutant.

36. The method according to claim 27, wherein the organism is rhizosphere competent.

37. The method according to claim 27, wherein the organism is selected from the group consisting of Trichoderma spp., Gliocladium spp., Rhizobium spp., Pseudomonas spp., Bacillus spp., and Enterobacter.

38. A method for removing pollutants from an environmental area comprising:
introducing fungi and bacteria to a polluted environmental area under conditions effective to allow the fungi to grow, thereby removing pollutants from the environmental area.

39. The method according to claim 38, wherein the fungi are strains of the genera Trichoderma.

40. The method according to claim 38, wherein the organism is capable of detoxifying polycyclic aromatic compounds.

41. The method according to claim 38, wherein the toxic substance is a simple or complex phenolic pollutant.

42. The method of claim 38, wherein the toxic substance is cyanide or a metallocyanide.

43. The method according to claim 38, wherein the fungi are mushrooms.

44. The method according to claim 43, wherein the mushrooms are selected from the group consisting of Pleurotis spp. and Agaricus spp.

45. The method according to claim 38, wherein the fungi are a combination of strains of the genera Trichoderma and mushrooms.

46. The method according to claim 38 further comprising:
providing aeration to the environmental area after said introducing.

47. The method according to claim 38, wherein the environmental area is soil.

48. The method according to claim 38, wherein the environmental area is water.

49. The method according to claim 48 further comprising:
introducing fungi to a porous support and
passing water containing pollutants through the porous support, wherein the fungi takes up the pollutants, or degrades the pollutants to a non-toxic or non-polluting form, thereby removing the pollutants from the water.

50. The method according to claim 49, wherein the pollutant is selected from the group consisting of nitrates, nitrites, phosphorus, potassium, iron, arsenic, nickel, lead, zinc, mercury, aluminum or copper.

51. The method according to claim 49, wherein the organism is rhizosphere competent.

52. A method of enhancing development of plant fine roots and root hairs comprising:
providing a plant;
providing one or more symbiotic rhizosphere competent microbes;
introducing the one or more symbiotic rhizosphere competent microbes to the plant under conditions effective for the one or more microbes to colonize the roots of the plant, thereby enhancing the development of plant fine roots and root hairs.

53. The method according to claim 52, wherein the microbe is a fungus or a bacterium.

54. The method according to claim 53, wherein the rhizosphere competent microbe is selected from the group consisting of Trichoderma spp., Gliocladium spp., Rhizobium spp., Pseudomonas spp., Bacillus spp., Burkholderia Streptomyces, and Fusarium.

55. The method according to claim 54, wherein the microbe is Trichoderma spp.

56. The method according to claim 55, wherein the microbe is Trichoderma harzianum.

57. The method according to claim 52, wherein the one or more symbiotic rhizosphere competent microbes comprises a fungus and a bacterium.

58. The method according to claim 57, wherein the fungus is selected from the group consisting of Trichoderma spp., Penicillium spp., Fusarium spp., and Rhizoctonia spp.

59. The method according to claim 57, wherein the fungus is Trichoderma spp.

60. The method according to claim 57, wherein the bacterium is a selected from the group consisting of Rhizobium spp., Bradyrhizobium spp., Pseudomonas spp., and Bacillus spp.

61. A method of increasing the yield of crop plants, said method comprising:
providing a crop plant or a crop plant seed;
providing a symbiotic fungal organism, wherein the organism is capable of colonizing plant roots and is selected from the group consisting of Trichoderma spp., Penicillium spp., Fusarium spp., and Rhizoctonia spp.;
providing a symbiotic bacterial organism, wherein the organism is capable of colonizing plant roots and is selected from the group consisting of Rhizobium spp., Bradyrhizobium spp., Pseudomonas spp., and Bacillus spp.;
combining the fungal organism and the bacterial organism with the crop plant or crop plant seed under conditions effective for the fungal organism and the bacterial organism to colonize the roots of the plant or a plant grown from the plant seed, thereby increasing the yield of the crop plant.

62. The method according to claim 61, wherein the crop plant is a legume.

63. The method according to claim 62, wherein the legume is a soybean plant.

64. The method according to claim 61, wherein the fungal organism is Trichoderma spp. and the bacterial organism is Bradyrhizobium spp.
